(19) United States
(12) Patent Application Publication
(10) Pub. No.: US 2024/0363008 A1
(43) Pub. Date: Oct. 31, 2024

(54) KINEMATICS MONITORING TOOL FOR MULTI-VEHICLE TESTING

(71) Applicant: TORC Robotics, Inc., Blacksburg, VA (US)

(72) Inventors: John HUTCHINSON, Blacksburg, VA (US); Nicholas GIGLIOTTI, Blacksburg, VA (US); Henry FORSYTH, Blacksburg, VA (US)

(21) Appl. No.: 18/307,732

(22) Filed: Apr. 26, 2023

(51) Int. Cl. G08G 1/16; B60T 7/22; B60W 10/18; B60W 30/09; B60W 30/095; B60W 50/14

(52) U.S. Cl. CPC G08G 1/166; B60T 7/22; B60W 10/18; B60W 30/09; B60W 30/095; B60W 50/14; B60W 2050/146

(57) ABSTRACT

Embodiments described herein include hardware and software components for hosting a multi-vehicle tool that configures and tracks test scenarios of an ego vehicle. Sensors mounted to the ego other traffic vehicles generate sensor data, including geolocation data, which the vehicles transmit to a system hosting the multi-vehicle tool. The multi-vehicle tool uses the sensor inputs to generate a user interface allowing an administrator to monitor the vehicles during testing. The multi-vehicle tool detects when the sensor data satisfies a configurable bail threshold and transmits a notification to an administrator to abort the test or transmits instructions to the ego vehicle to abort the test.

### TECHNICAL FIELD

This application generally relates to testing automated vehicles. In particular, the application generally relates to systems and methods for tracking and configuring parameters, such as abort thresholds, of closed-course and open-course testing operations.

### BACKGROUND

For safety reasons, automated vehicle developers and manufacturers must monitor a distance, time-to-collision, and other kinematics when performing closed-course test scenarios. These closed-course test scenarios typically involve an automated vehicle (sometimes referred to as an “ego” or “ego vehicle”) interacting with one of more traffic vehicles performing various driving behaviors, such as cut-ins, merges, lane changes, and other actions.

In certain circumstances, the automated vehicle must abort the test scenario (sometimes referred to as “bailing” or a “bail”). The automated vehicle monitors various kinematic measurements to determine whether those measurements satisfy a bail threshold. If a certain bail threshold based on headway or time-to-collision is satisfied, then the automated vehicle safely aborts to avoid a potential collision.

A conventional approach to testing employed handheld rangefinders that generate and track kinematic measurements for the automated vehicle. Rangefinders, however, may be insufficient, inefficient, and sometimes ineffective. Problems with rangefinders may include: difficulty of using the rangefinder while also maintaining situational awareness; insufficient accuracy; and inability to perform real time or near-real time calculations of bail thresholds.

Another approach employs the onboard sensors of the automated vehicle for determining kinematics and evaluating bail thresholds. The existing sensors, however, may be insufficient. For instance, the existing sensors often produce insufficient accuracy of detected objects and related information about those objects, such as inaccurate estimated velocities for other traffic vehicles.

### SUMMARY

What is needed is an improved means for capturing and generating accurate kinematic information in real time or near-real time. What is further needed is an improved means of assessing kinematic information against bail thresholds in real time or near-real time.

Some prior approaches used sensors of an ego vehicle to detect the relative distance, speed, and acceleration of a traffic vehicle and calculate a time-to-collision value to automatically actuate brakes and prevent collisions (e.g., Automatic Emergency Braking). However, these solutions generally used sensors, such as radar or cameras, installed on the ego vehicle, and therefore may have lower accuracy than high-precision GPS. Moreover, performance can be impacted by sensor calibration or environmental conditions. Additionally, these conventional solutions are not intended for testing, and do not provide a user interface that displays the relevant kinematic information to a vehicle operator for testing, development, or operational purposes.

Embodiments described herein address the shortcomings mentioned above and may provide additional or alternative benefits as well. Embodiments described herein include hardware and software components hosting and executing a multi-vehicle kinematics measurement program (sometimes referred to as a “multi-vehicle tool”) that allows a test administrator to configure and track the test scenarios applied to a particular automated vehicle (sometimes referred to as an “ego” or “ego vehicle”). Sensor devices mounted to the ego vehicle and other traffic vehicles generate and forward sensor data to a computing system hosting and executing the multi-vehicle tool. The sensors of the ego and the traffic vehicles include hardware and software components of an Inertial Navigation System (INS) device and Global Navigation Satellite System (GNSS) device. The ego vehicle and traffic vehicles include a wireless network interface device (sometimes referred to as a “wireless link” or “wireless device”), which couples to a controller (or other processor device) or to the sensors and allows the ego vehicle and traffic vehicles to communicate sensor data to the multi-vehicle tool system.

A client device operated by a developer interacts with a user interface. The multi-vehicle tool includes processes for generating, updating, and presenting the user interface based upon the sensor data or kinematic data received from the sensor devices of the vehicles. Components of the multi-vehicle tool may be locally installed on, and executed by, a client device. Alternatively, the multi-vehicle tool includes a web-based application (“web-app”) hosted by a server and accessed by the client device through a webpage using browser software (“browser”). The INS calculates, for example, a position and velocity of each vehicle and transmits the measurements over the wireless network to the client device or server. The multi-vehicle tool calculates kinematics data, such as distance, direction, headway, bail threshold, and velocity differences between the ego and each traffic vehicle. The user interface displays the various types of information, offering a visual representation of when a configurable bail threshold or a headway limit is reached. The test scenario can be safely aborted by the developer sending instructions to the autonomy software of the automated vehicle or by the automated vehicle, thereby protecting against collisions.

In an embodiment, a method comprises receiving, by a computer, location data from an automated vehicle and a traffic vehicle; determining, by the computer, a first location for the automated vehicle and a second location for the automated vehicle based upon the location data; determining, by the computer, a position of the traffic vehicle relative to the automated vehicle using the location data; generating, by the computer, kinematics data using the location data, first location, the second, and the position of the traffic vehicle; and in response to the computer determining that a value of the kinematics data satisfies a bail threshold, generating, by the computer, a bail notification for the automated vehicle.

In another embodiment, a system comprises a non-transitory machine-readable storage configured to store machine-readable software instructions and one or more bail conditions; and a computer comprising a processor coupled to the machine-readable storage. The computer is configured to receive location data from an automated vehicle and a traffic vehicle; determine a first location for the automated vehicle and a second location for the automated vehicle based upon the location data; determine a position of the traffic vehicle relative to the automated vehicle using the location data; generate kinematics data using the location data, first location, the second, and the position of the traffic vehicle; and in response to determining that a value of the kinematics data satisfies a bail threshold, generate a bail notification for the automated vehicle.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views. The accompanying drawings, which are incorporated in and constitute a part of this specification, illustrate various exemplary embodiments and together with the description, serve to explain the principles of the disclosed embodiments.

FIG. 1A shows components of a testing environment for testing automated vehicles in a closed-course or open-course testing scenario, according to an embodiment.

FIG. 1B is a schematic representation of computing components of a system implementing a multi-vehicle tool that monitors kinematic information for the testing environment of FIG. 1A, according to the example embodiment.

FIGS. 2A-2C show instances of a user interface generated by a multi-vehicle tool in various circumstances using location data, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

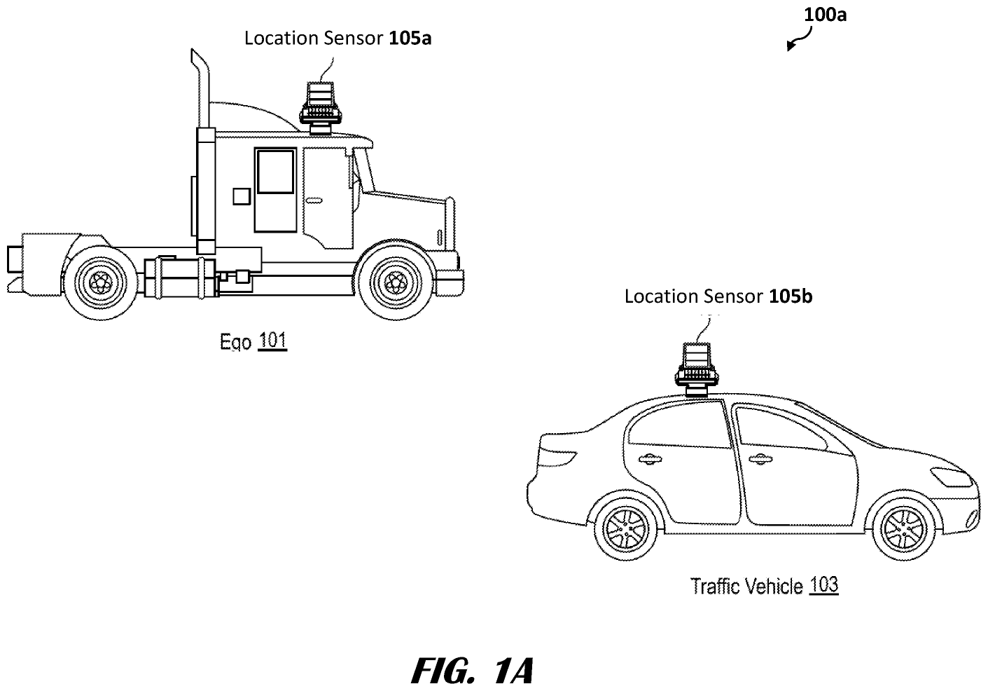

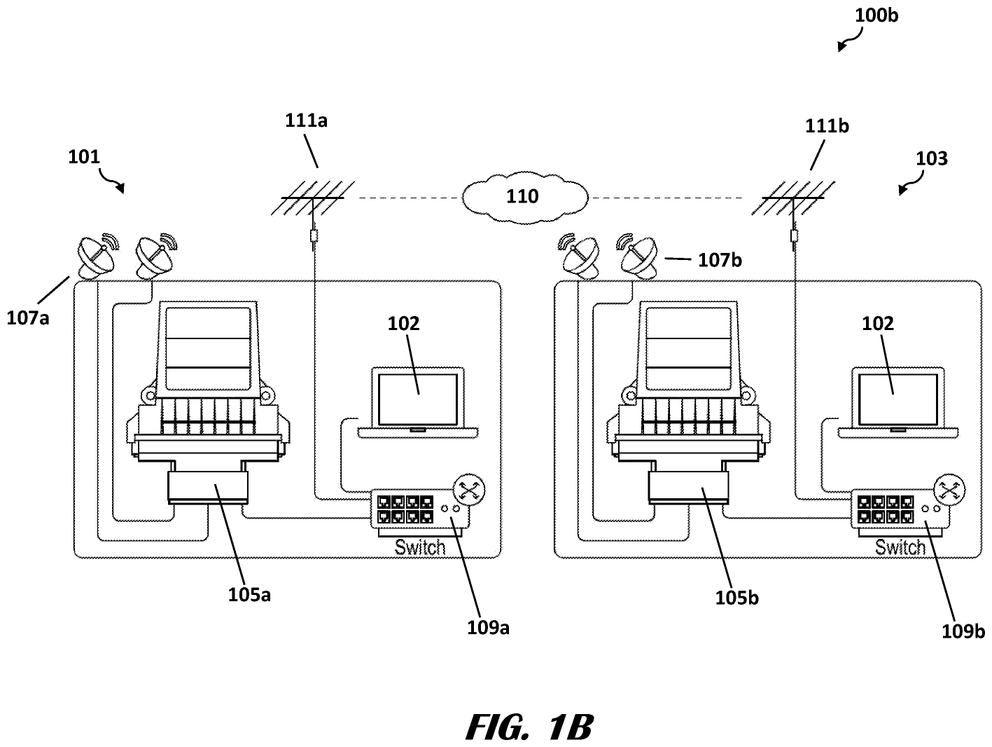

FIG. 1A shows components of a testing environment 100a for testing automated vehicles in a closed-course or open-course testing scenario. The testing environment 100a includes the ego vehicle 101 under test, and one or more traffic vehicles 103 operating on the course. The ego vehicle 101 includes an automated vehicle under test. The traffic vehicle 103 may be a human-operated vehicle, another automated vehicle, or an inoperable vehicle (parked or otherwise stationary).

FIG. 1B is a schematic representation of components of a system 100b implementing a multi-vehicle tool that monitors kinematic information for the testing environment 100a. Each vehicle 101, 103 includes components of the multi-vehicle tool for gathering various types of information, such as a location sensor 105a-105b (generally referred to as a location sensor 105) having a satellite communication interface 107a-107b (generally referred to as a satellite interface 107), a wireless communication interface 111a-111b (generally referred to as a wireless interface 111) for communicating via one or more networks 110, and one or more data routing devices 109a-109b (generally referred to as a routing device 109) for directing data packets between computing devices via the network 110. The system 100b includes one or more computing devices 102, such as a client device or backend server. As shown in FIG. 1B, each vehicle 101, 103 communicates with the same computing device 102. However, in some cases, each vehicle 101, 103 includes a distinct computing for performing local management and testing functions for operating the particular vehicle 101, 103.

The data routing device 109 includes any computing device comprising hardware and software components capable of directing data packets over the network 110. In some cases, each vehicle 101, 103 includes an internal network allowing devices of the particular vehicle 101, 103 to communicate with one another. The data routing device 109 routes the data packets generated by the location sensor 105 or the computing device 102, from a source device to a destination device. Non-limiting examples of the data routing device 109 includes a switch, a router, and the like.

The location sensor 105 includes hardware and software components of an INS/GNSS device for generating various types of geolocation or position information about the particular vehicle 101, 103. The location sensor 105 communicates with one or more satellite navigation systems via the satellite interface 107 to gather and generate location information. In some cases, the location sensor 105 communicates the location information to the computing device 102 via the internal or external network 110, as directed by the routing device 109. In some cases, the location sensor 105 communicates the location information to another vehicle 101, 103 via the networks 110, as directed by the data routing devices 109.

The computing device 102 may be any computing device comprising non-transitory machine-readable storage for storing and executing executable instructions of the software programming of the multi-vehicle tool. In some implementations, the multi-vehicle tool accesses stored configurations (e.g., bail conditions) and other types of information stored in a database (not shown) or other non-transitory machine-readable storage, such as the memory storage of a backend storage or client device.

In operation, the computing device 102 executes the software of the multi-vehicle tool, which ingests the various types of information from the location sensors 105 and, in some cases, other types of sensors. In some embodiments, the computing device 102 includes a client device that locally executes some or all of the processes of the multi-vehicle tool. Additionally or alternatively, in some embodiments, the computing device 102 includes a backend server that hosts and executes some or all of the processes of the multi-vehicle tool, and the client device executes a browser that accesses and interacts with the multi-vehicle tool.

The multi-vehicle tool generates and manages a user interface that displays various types of information about the ego 101 and traffic vehicles 103 as the testing scenario progresses. In addition, the multi-vehicle tool generates various types of kinematic measurements extrapolated from the location information received from the vehicles 101, 103. The user interface presents the location information received from the location sensors 105 and the kinematic data generated by multi-vehicle tool. The location sensor 105 of each vehicle 101, 103 calculates a position and velocity of the vehicle 101, 103 and transmits the measurements over the wireless network 110 to the computing device 102. Using the data received from the vehicles 101, 103, the computing device 102 (executing the multi-vehicle tool) calculates the kinematics data, such as distance, direction, headway, bail threshold, and velocity differences between the ego 101 and each traffic vehicle 103. The multi-vehicle tool updates the user interface to display the various types of information, offering a developer a visual representation of when a user-configurable bail threshold or a headway limit is reached.

In some embodiments, the developer sends an abort instruction to the ego 101 (and/or traffic vehicle 103) instructing the driving autonomy software of the ego 101 to halt operations and safely abort the testing scenario. In some embodiments, the multi-vehicle tool detects that the kinematics data satisfies the bail threshold or headway limitation, and automatically pushes the abort instruction to the driving software of the ego 101 (and/or traffic vehicle 103) to halt operations and abort the testing scenario.

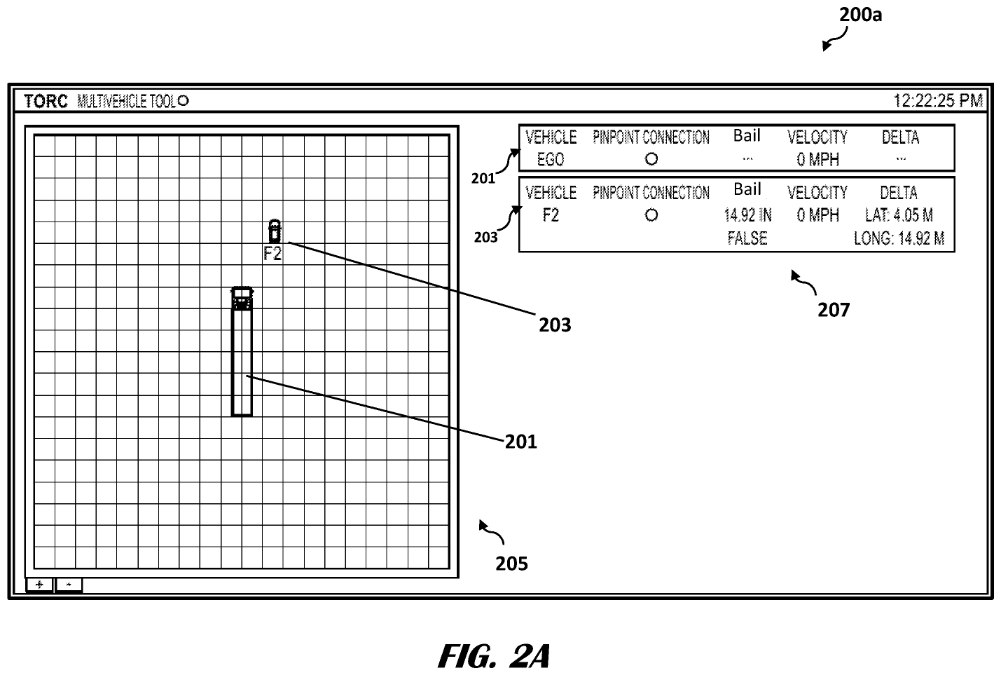

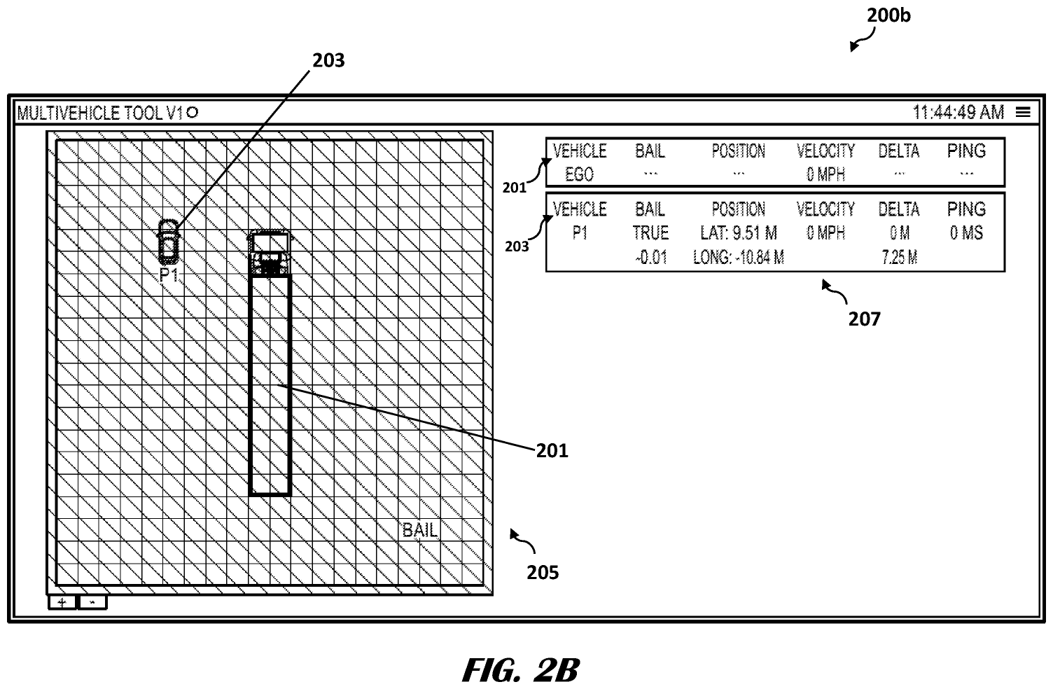

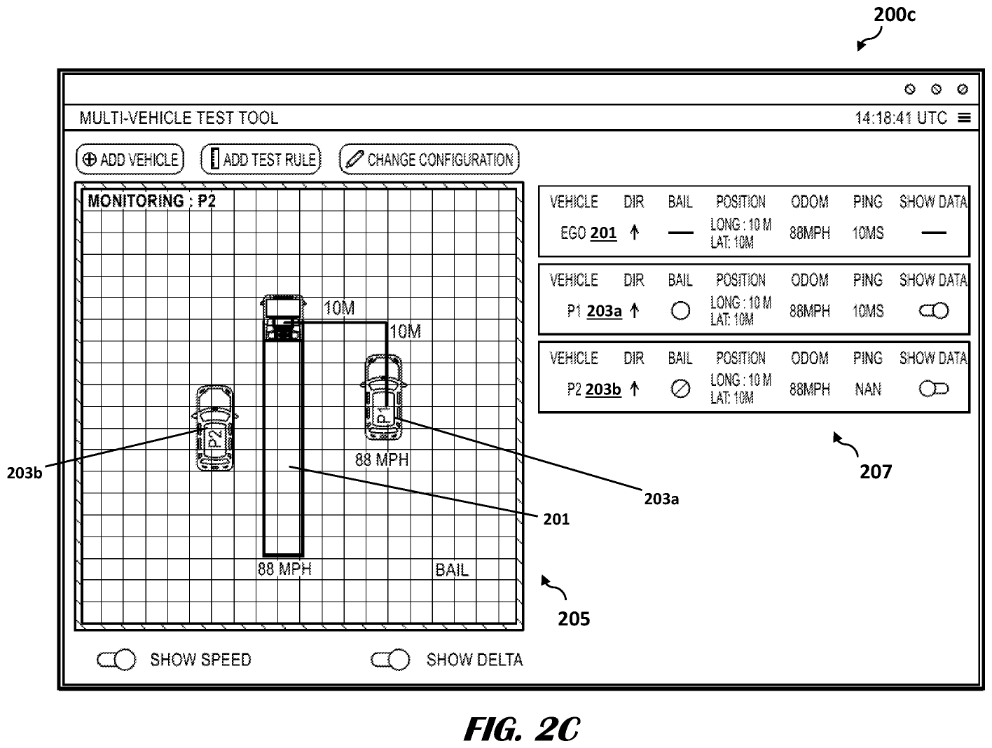

FIGS. 2A-2C depict a user interface 200a-200b generated by a multi-vehicle tool in various circumstances using location data, according to an embodiment.

As shown in FIG. 2A, the user interface 200a includes different forms of visual outputs for displaying relevant information about an ego vehicle 201 and one or more traffic vehicles 203a-203b (generally referred to as a “traffic vehicle 203”). The visual outputs include a graphical presentation 205 and a data presentation 207, based on the location information and kinematics data. The graphical presentation 205 includes a graphical representation depicting the relative positions of the ego vehicle 201 and traffic vehicle 203 in a given space or testing environment. The data presentation 207 displays various types of information for each particular vehicle 201, 203. The information of the data presentation 207 includes, for example, a vehicle name or identifier, a connectivity quality indicator for a location sensor, a bail condition status, vehicle velocity, and a calculated distance from the ego 201 to the traffic vehicle 203.

FIG. 2B shows an example of the user interface 200b when the multi-vehicle tool detects that the kinematics data satisfies the bail condition. The information of the data presentation 207 includes the vehicle names, the bail condition status, the vehicle locations or positions, the vehicle velocities, and the calculated distance from the ego 201 to the traffic vehicle 203. The multi-vehicle tool determines the bail condition is satisfied when, for example, the relative distance satisfies the bail threshold that governs a permissible relative distance.

FIG. 2C shows an example of the user interface 200c when the testing scenario involves multiple traffic vehicles 203. The user interface 200c presents additional types of information in the graphical representation 205 and the data representation 207 and also includes additional user-selectable options for presenting information or configuring one or more bail thresholds. In this example, the multi-vehicle tool detected that the kinematics information satisfies a bail threshold between a traffic vehicle 103b and the ego 101. Accordingly, the user graphical representation 205 indicates that the multi-vehicle tool detected that the kinematics data satisfied the bail condition. Moreover, the data representation 207 for the traffic vehicle 203b indicates that the bail condition was satisfied with respect to that particular traffic vehicle 203b.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by a computer, location data from an automated vehicle and a traffic vehicle;
determining, by the computer, a first location for the automated vehicle and a second location for the automated vehicle based upon the location data;
determining, by the computer, a position of the traffic vehicle relative to the automated vehicle using the location data;
generating, by the computer, kinematics data using the location data, first location, the second, and the position of the traffic vehicle; and
in response to the computer determining that a value of the kinematics data satisfies a bail threshold, generating, by the computer, a bail notification for the automated vehicle.

2. The method according to claim 1, further comprising generating, by the computer, a user interface based upon the location data and the kinematics data.

3. The method according to claim 2, wherein the user interface includes at least one of a graphical representation or data representation based upon the location data and the kinematics data.

4. The method according to claim 1, wherein the computer generates the bail notification for display at a user interface.

5. The method according to claim 1, wherein the computer generates the bail notification containing machine-readable instructions causing the automated vehicle to halt.

6. The method according to claim 1, further comprising receiving, by the computer, a configuration input indicating the bail threshold via a user interface.

7. The method according to claim 1, wherein the computer receives the location data from a location sensor of the automated vehicle.

8. A system comprising:
a non-transitory machine-readable storage configured to store machine-readable software instructions and one or more bail conditions; and
a computer comprising a processor coupled to the machine-readable storage, the computer configured to:
receive location data from an automated vehicle and a traffic vehicle;
determine a first location for the automated vehicle and a second location for the automated vehicle based upon the location data;
determine a position of the traffic vehicle relative to the automated vehicle using the location data;
generate kinematics data using the location data, first location, the second, and the position of the traffic vehicle; and
in response to determining that a value of the kinematics data satisfies a bail threshold, generate a bail notification for the automated vehicle.

9. The system according to claim 8, wherein the computer is further configured to generate a user interface based upon the location data and the kinematics data.

10. The system according to claim 9, wherein the user interface includes at least one of a graphical representation or data representation based upon the location data and the kinematics data.

11. The system according to claim 8, wherein the computer is further configured to generate the bail notification for display at a user interface.

12. The system according to claim 8, wherein the computer is further configured to generate the bail notification having machine-readable instructions causing the automated vehicle to halt.

13. The system according to claim 8, wherein the computer is further configured to receive a configuration input indicating the bail threshold via a user interface.

14. The system according to claim 8, wherein the computer is further configured to receive the location data from a location sensor of the automated vehicle.
